(19) United States
(12) Patent Application Publication
(10) Pub. No.: US 2003/0061385 A1
(43) Pub. Date: Mar. 27, 2003

(54) Computer network interpretation and translation format for simple and complex machines

(76) Inventor: Lucas Gonze, Brooklyn, NY (US)

Correspondence Address: Greenberg and Lieberman Law Offices, 314 Philadelphia Ave., Takoma Park, MD, 20912, US

(21) Appl. No.: 09/867,669

(22) Filed: May 31, 2001

(51) Int. Cl. G06F 15/16

(52) U.S. Cl. 709/246

(57) ABSTRACT

The present invention is development framework that can relay messages in varied formats. The present invention can relay messages in any format from one node to another. Each message can be delineated to a generic message object and interpreted by the present invention to allow any message in any format to be read on any of the nodes regardless of format. The invention minimizes the amount of computing power required for a device to participate in a network.

### REFERRENCE TO EARLIER APPLICATION

Priority is hereby claimed to Provisional Patent Application No. 60/208,093 filed on May 31, 2000 in the name of Lucas Gonze for a Framework for Distributed Applications.

### BACKGROUND OF THE INVENTION

The technology era has brought businesses and homes alike a new ability to tap into varied information sources, broadening customer bases and allowing consumers to purchase from stores that are not in their area or are only web based. Efforts to enable computers to share data over networks typically use the lingua franca strategy: they offer a design for a common language that computers must adopt if they wish to join the network. This creates problems when attempting to connect computing devices with significantly different capabilities. These differences include a broad array of operating systems and processing capacity. Operating systems span not just those popular on personal computers—Windows, Unix, Linux, BeOS, MacOS and DOS—but also those used on portable devices such as cell phones, those used on very weak devices such as a the windshield wipers in an automobile, and those used on very powerful devices such as Beowulf supercomputing clusters. Processing capacity varies from gigabytes of RAM on a supercomputer down to a few hundred bytes on a household appliance. These systems each have their own advantages or disadvantages, but they do not easily communicate with each other. This creates problems when transferring files or information from one type of device to another, for example for the purposes of remote procedure calls (RPC). The information may be fragmented, or not transfer at all. HTTP (HyperText Transport Protocol) is used as a common protocol to allow many computers to share data, for example to work collectively via remote procedure calls. However, computers must have a minimum level of computing power to use HTTP, and there exist many devices below that level (such as printers, scanners and facsimile machines) that would need extra programming or added hardware to do so. Using HTTP on these devices can be costly enough to be impractical.

An additional problem with programs that work over networks is that a user does not have the same degree of control over the computing environment as they do with a program that operates solely on the user's machine. On the user's local machine they are able to upgrade or change components to fit the requirements of a program. For example, they may upgrade the system to handle new types of XML. For programs that operate over networks the user may not have the ability to make changes on other's machines. In such a situation the lingua franca strategy cannot be used.

Sun Microsystems has a program, Jini, which addresses the same goal of joining heterogeneous devices. However it requires that all the devices run Java.

Therefore a need has been established for a technology framework that enables devices to share information without having to adopt a lingua franca.

### SUMMARY OF THE INVENTION

The present invention is based on the principle that systems are heterogeneous by design, and this fact can be used in a complimentary manner instead of attempting to change all parts of each system into one format. The present invention is an application framework for messages transferred over many different protocols. The present invention maps different types of incoming messages to a common format. This format is then passed to generic message handlers. The present invention also has a generic callback engine that supports multiple protocols at the same time.

The present invention has a protocol that delineates messages to the lowest common factor. In this manner the present invention may be used on devices that cannot handle higher protocols, such as digital phones, palm pilots, and other technologies that do not have the memory or capacity to run all message types. The protocol is optional in each instance and the user may choose to implement the translation of the messages or to leave the messages in the original format.

The present invention also has a bridge feature to connect nodes (or devices that are sending messages to each other). The bridge feature can relay the messages from one format in one node, to another format in another node so that each node may read the message. The term node is used here in favor of computer because the nodes do not need to be computers but instead only need to be a machine or program that can read messages of some type.

The present invention also has a Generic Callback handler that filters the messages and determines the correct route for each message. The message will come into the system in a certain format and then can be translated into the specific formats as needed for transferring the message.

The present invention can transfer messages of any type, in any readable format. The information may be relayed by disc, CD, over the Internet, or flat file transfer. The present invention does not require the nodes to translate advanced XML. The present invention works through Java but does not require that compatible or equivalent nodes work through Java. The protocol is also unidirectional, because there are nodes that can either send data or receive data but not both. Also included is a point to point map so that each node does not need to keep a registry of applicable message type for each computer it may communicate with. In this manner the General Callback Function can translate each message along the point to point map to be read by each node in the chain of the message. Any protocol available to the nodes is usable for the present invention as the intent is to build bridges of communication from one node to the next, instead of requiring that each node be on the same or complimentary protocols.

The present invention is aimed at low-tech devices, but can also easily communicate with high-end technology. For example the present invention could communicate signals with a common household appliance, which could not handle advanced technology such as SQL databases, or crypto functions. However the household appliance can, through use of the present invention be put in communication with the household computer which has the capability to understand these higher end functions, and the present invention can translate the functions to the household appliance.

The present invention also uses compound protocol technology. It works with the different protocols of the nodes that are communicating, as opposed to requiring all nodes to use the same protocol. This is implemented by bridge nodes that read and reformat the communication into separate formats readable to each separate node. The invention accomplishes the above by means of a local sponsor or generic message handler for each remote node. The handler is responsible for converting messages between the specific protocol from each node to the generic format, invoking generic message handlers, and forwarding messages to other sponsored remote nodes, as coded in the message. There is an ongoing flow of messages between remote nodes that is mediated by the invention, with some messages being passed between pairs and some being spread out for broadcast.

### BRIEF DESCRIPTION OF THE DRAWINGS

FIG. 1 shows a flow chart of the relay of a single message within a single node with one single connection to a remote node.

FIG. 2 shows a relay of multiple messages within a single node with multiple connections to remote nodes.

### DETAILED DESCRIPTION OF THE PREFERRED EMBODIMENT(S)

The present invention is a framework for computers and other machinery that allows nodes using different protocols to communicate. The present invention takes a message from one node and translates the message to appropriate protocols for forwarding to other nodes. A generic message handler intakes each message for the community and redistributes the message in readable formats and protocols to each node.

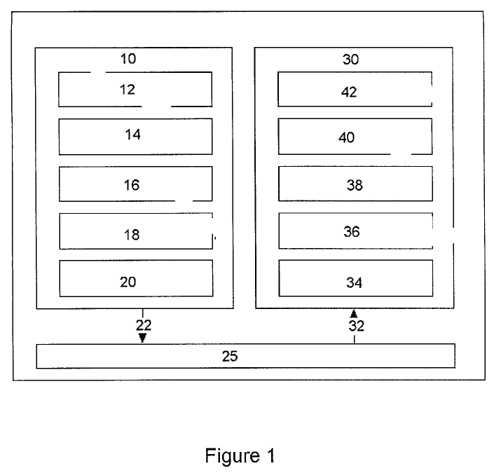

FIG. 1 shows a flow chart of the relay of a message from one node to another using the present invention. On the left side of the figure is the reading of a message (10). The first pathway the message travels through is a protocol handler. This may be any of a number of optional protocol handlers, including an HTTP protocol handler (12), a Goa protocol handler (14), an SMTP protocol handler (16), a Curses protocol handler (18), or a CORBA protocol handler (20). The HTTP protocol handler may be invoked because a web browser is connected to this node. Similarly, the SMTP protocol handler may be invoked for messages received via email, the Curses protocol handler for a user who has connected to this node by means of the telnet program, etc.

The protocol handlers (14, 16, 18, 20) can reduce the message from its original format to a less specialized format, but the conversion is not required. For every incoming message, the read from method of every loaded Transport Handler (14) may be called until either the list of possible protocols is exhausted or one of the Transport Handlers (14) is able to understand the message.

The filtering of the read from message from the read from message node (10), through either the HTTP protocol manager (12), the GOA protocol handler (14), and the SMTP Protocol Handler (16), the curses protocol handler (18), or the Corba protocol handler (20) creates a generic message object (22). The generic message object (22) moves to the generic message handler (25). The generic message handler (25) interprets the generic message (22) to activate a subroutine corresponding to the semantic requirements of the message (25). For example, an HTTP message requesting that a file be read into memory and returned over the network would cause a subroutine (25) able to do this to be invoked. Any protocol able to convey this semantic (a request for a file) would cause the same corresponding subroutine to be invoked.

The generic message object (22) is then converted to the proper format and transferred to the write to message function (30) in the form of the second generic message object (32). The second generic message object (32) is filtered through either the second Corba protocol handler (34), the second curses protocol handler (36) or the second SMTP protocol handler (38). The write-to protocol handler invoked is the same one used for the read-from operation. The second protocol manager (40) then relays the second generic message object (32) so that the remote node may make use of the results of the subroutine (25) on the write-to node.

The first and second generic message objects (22,32) are exchanged with the remote node (10) in use of compound protocol techniques. Messages may be translated from email format to telnet format if the proper handlers {the protocol handler (14), the SMTP Protocol Handler (16), the curses protocol handler (18), or the Corba protocol handler (20)} are available for the message on each node (10,30) and there are semantically equivalent operations across the different protocols. The gateway node can translate the message to any format and relay the message from the read from message node (10) to the write to message node (30). This allows generic message objects (22, or 32) to be relayed from complex machines such as computers to low technology machines such as household appliances. The read from message node (10) and the write to message node (30) can be either server or client—either role will work.

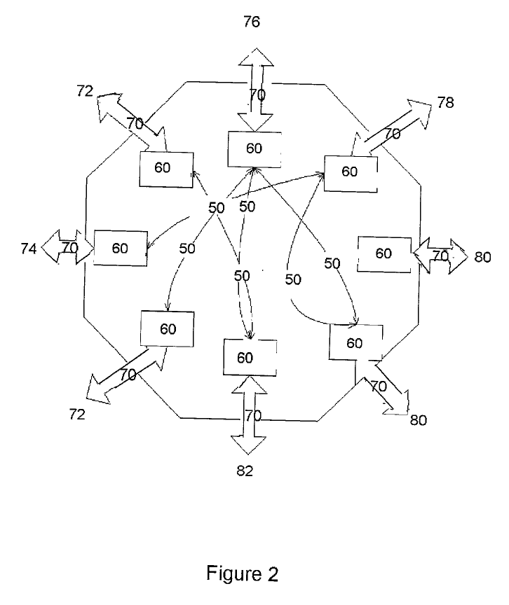

To convert messages from one protocol to another, there does not need to be a protocol handler for both in a single node. Instead there can exist a chain of connected nodes of any length and any intermediate protocols, given that the beginning protocol and the ending protocol are supported at the endpoint gateway nodes (FIG. 2), and that any directly linked nodes in the chain share a common protocol handler. Any two nodes that share a common protocol can be links in the chain.

FIG. 2 shows the relay of message objects with a node. In the center of the flow chart are arrows indicating the generic message objects (50). The generic message objects (50) are relayed through a peer connection (60) object, with one peer connection object for each connection to a remote node. The protocol specific messages (70) are relayed from the peer connections to each node. As is shown in the chart the protocol specific messages can then be read by the user by use of a web browser (72), by a Java node using RMI (74), by a Corba Client (76), by an email program (78), by GOA peers (80), or by means of any terminal connection (82). The web browser (72), Java node using RMI (74), Corba Client (76), email program (78) and terminal connection (82) function in conventional manners. The GOA peers (80) are nodes that are instances of the present invention.

Mapping protocol specific messages (70) to generic message object (22) can be achieved in two ways. The first possibility is that the protocol specific message (70) is converted to the generic format by means of code which understands both the protocol specific format and the generic format Below are possible examples of Java code for the read from message node (10) and the write to message node (30).

Read from message node (10) code example

/** Convert an HTTP message to a generic message object.

We simply create a generic message object of type corresponding
to the HTTP object on a semantic level.

*/
public Object read a message (InputStream is){

//read and parse the incoming request
HttpRequest hr = new HttpRequest(is);
//create XML string that is semantically equivalent
//using data from the HTTP request
String st = makeGenericMessageObject(hr.getVar(“function”));
return(st);

}

Write to message node (30) example

/** Convert a generic message object to an HTTP message.

We simply send the XML as mime type text/plain.

*/
public void write (Object msg, OutputStream conn) {

st = “HTTP/⊥.⊥ 200 OK”+CRLF

+ “Content-type: text/plain”
+ CRLF
+ CRLF
+ msg.toString()
CRLF
;

conn.writeTo(st);

}

Another option for protocol specific messages (70) is that a protocol specific message object has a superset of the functionality of a generic message object. In the terms of object oriented programming, there would be a base class (an interface in Java or a template in C++) with generic functions, and protocol-specific message classes would be derived from it. A protocol-specific message class preserves the original message untouched and verbatim as received, but encapsulates it in the manner and for the purposes of traditional object oriented programming.

Regardless of how the generic message object is created—by conversion or object derivation—the message is handled by a subroutine that accepts a generic message object. In the below example in Java code, the incoming message is visible as a Message object rather than an RMI message object, a Corba message object, or any other protocol specific type.

abstract public class FuncHandler {
/**

@return true to close the connection, false to keep it open

*/

```
  abstract public boolean funcMain
  ( XMLServConnection conn, Message msg )
```

throws XMLServException;

}

There are two types of motion that a message can take from a read from message node (10) to a write to message node (30), undirected and directed. Undirected motion is oriented towards functionality instead of geography. For example three nodes A, B, and C attempt to fulfill a request. A forwards the message to B so that B could fulfill the criteria. B cannot fulfill the criteria and so B forwards to C.

There are no specific individuals or entities required. If B has the information instead of C, B will then answer A directly. If C has the information requested it may answer B which can forward to A.

Directed motion is oriented towards specific entities: a message must go by one path only. The message returned by C must make its way to A, so there is an implicit geography where A is the direction of motion for the message.

Stack routing is the algorithm that allows each computer to know the capabilities of the other nodes. Using the above example when B did not have the information requested and forwarded the message to C, B enclosed data for its own use later. When C responded to B, C included that context information. B picked up the context, which said that the original message was from B's connection to A, and used it to forward the response to the correct destination.

Every node has an identifier for each direct connection. For example, A is connected to B, A's identifier for B is Ab and B's identifier for A is Ba. If B is connected to C, there are Bc and Cb. These identifiers are entirely relative to the node that owns the connection. There is no global association between Ab and Ba, they do not need to be directly linked to work.

Please see the example below of information moving from A to B to C to D and vice versa.

State tracking in Stack Routed Messages

| | | IDENTIFIERS |
|---|---|---|
| | | AND STACKED |
| NODE | Message Or Request | STATUS |
| A | Sends initial request to B | null |
| B | Pushes the connection to A onto the stack | Ba |
| | Forwards the message to C | |
| C | Pushes the connection to B onto the stack | Cb |
| | Forwards the message to D | Ba |
| D | Returns an answer to C | Cb |
| | without touching the stack | Ba |
| C | Pulls its context, and identifier | Ba |
| | off the top of the stack | |
| | Reads the context to determine | |
| | that this message is | |
| | bound for B | |
| | Sends the message to B | |
| B | Pulls its context, and identifier | null |
| | off the top of the stack | |
| | Reads the context to determine | |
| | that this message is bound for A | |
| | Sends the message to A | |
| A | Pulls its context and identifier off the stack, | n/a |
| | Reads the context to figure out that A is the | |
| | originator of the message | |
| | Uses the returned information | |

In addition to storing the routing path in a stack that grows or shrinks by one element at each hop in a chain of intermediaries, the present invention maintains the stack recursively rather than as a list. A stack maintained as a list may be thought of as an ordered sequence of entries.

A Stack Defined as a List:

Datum 1

Datum 2

Datum N

A stack defined recursively allows elements to be themselves a recursively defined stack. The structure of a single entry in a recursively defined stack is defined recursively, as:

A Stack Defined Recursively:

Datum 1

Datum 2

Datum N

A Stack Defined Recursively:

Datum 1

Datum 2

Datum N

A Stack Defined Recursively:

Datum 1

Datum 2

Datum N

The purpose of defining the stack recursively is to enable each intermediary node to store state in the message without revealing that state to any other node that receives the message. When a node adds its state to the stack before forwarding it, as it does when saving the return path to the node from which it received the message, it places that data in a discrete element that the receiving node does not need to look at. For the receiving node, the only thing that matters is that the top of the stack is available to store its own state. Thus each node in the chain A, B, C, and D can encrypt its state before pushing it onto the stack. In this manner a sequence of intermediaries can all use the stack to store state (most importantly the return path) without revealing that state to one another.

Decryption is performed in the following manner. When a node receives a message with a recursive stack that it has encrypted, it decrypts the stack, reads its private state data, restores the stack to the state it was in when first received, and uses the state data to forward the message back to the originatorin this manner each node only reads the context pertinent to itself Although there may be instances in which the message needs to pass through each node on the network, these instances are limited. For this reason a ttl code can be inserted in each message to determine the number and which nodes that the message passes through. The default ttl code is three nodes. If the answer is not determined from the three nodes the request will expire and can be resent from the originator node.

Due to the stack routing feature and identifiers the present invention can easily recreate the path of the message by backtracking through the identifiers. The identifiers create a “breadcrumb” trail that can be reversed to determine the path of the message. The pushstack function records the information for possible backtracking of the message. The popstack function allows the pushstack function to be read and the message to be backtracked. Please see the table below for further explanation.

State tracking in Bi-directional Stack Routed Messages

| | | PUSH- | POP- |
|---|---|---|---|
| | | STACK | STACK |
| | | AT | AT |
| WHO | WHAT | RECIPIENT | RECIPIENT |
| A | Sends initial undirected request to | null | null |
| | B | | |
| B | Pushes the connection to A onto | Ba | null |
| | the pushstack | | |
| | Forwards the undirected message | | |
| | to C | | |
| C | Pushes the connection to B onto | Cb | null |
| | pushstack | Ba | |
| | Forwards the message to D | | |
| D | Returns an answer to C. | null | Cb |
| | (Direction is reversed by | | Ba |
| | swapping the pushstack and | | |
| | popstack) | | |
| C | Pops its context off the top of the | Cd | Ba |
| | popstack | | |
| | Determines that this message is | | |
| | bound for B | | |
| | Sends the message to B | | |
| | Pushes the return path to D onto | | |
| | the pushstack. | | |
| B | Pops its context off the top of the | Bc | null |
| | popstack | Cd | |
| | Determines that this message is | | |
| | bound for A | | |
| | Sends the message to A | | |
| | Pushes the return path to C onto | | |
| | the pushstack. | | |
| A | Pops its context off the popstack, | n/a | n/a |
| | Determines from the context that | | |
| | it is the originator of the message | | |
| | Uses the information requested. | | |
| | It may now send directed | | |
| | messages to D by swapping the | | |
| | stacks and writing to B. | | |

Below is an example of the message as above in XML code:

<msg>
<protocol>

<function>debug</function>

```
  </protocol>
  <funcdata>
```

<pushstack>
<stack>

<conn_id>0.4515119135085791</conn_id><!--
this might be B's ID for A -->

```
  </stack>
</push>
<popstack>
  <stack>
```

```
<conn_id>0.adf72814</conn_id><!-- this is B's ID for C -->
<stack>
  <conn_id>!%@%@%@%</conn_id><!--
  this is C's ID for D -->
</stack>
```

</stack>
</push>

</funcdata>
</msg>

The above method of establishing a path for routing messages along a chain of intermediaries allows the invention to avoid a need for message routing tables within each node. A message routing table stores routing path information in a table within the node, rather than in the message. By storing routing path information within the message, the present invention reduces the computing burden on intermediary nodes. In so doing the present invention enables devices without sufficient computing resources to maintain an adequate message routing table.

The present invention is not limited to the sole embodiments described above but encompasses any and all embodiments of the following claims.

I claim:

1. A computer network interpretation system, comprising:
at least one message object,
at least two nodes relaying said at least one message object,
a generic message object handler for interpreting said at least one message object; and
at least one protocol in said at least one message object.

2. A computer network interpretation system, as in claim 1, wherein said at least one message object is protocol specific in nature.

3. A computer network interpretation system, as in claim 1, wherein said at least one message object is inspecific in protocol.

4. A computer network interpretation system, as in claim 1, wherein said at least one message object is relayed from one of said at least two nodes.

5. A computer network interpretation system as in claim 4, wherein said one message object is intercepted by said generic message object handler.

6. A computer network interpretation system as in claim 5, wherein said one message object may be reformatted to separate protocol than the inherent protocol, by said generic message object handler.

7. A computer network interpretation system as in claim 6, wherein said one message object is relayed by said generic message object handler to the non-initiating node of said at least two nodes.

8. A computer network interpretation system, comprising:
at least two nodes, either complex or simple machines,
a means of connection between said at least two nodes,
at least one message object, protocol specific, or non-protocol specific, relayed from one of said at least two nodes to the other of said at least two nodes via said means of connection; and
a generic message object handler which interprets said at least one message object into a readable protocol in the relay of said at least one message object from one of said at least two nodes to the second of said at least two nodes.

9. A computer network interpretation system, as in claim 8, wherein said at least two nodes may be computers, cellular phones, personal organizational devices, pagers, or any household appliance with the ability to communicate with another machine.

10. A computer network interpretation system as in claim 8, wherein said at least one message object may be relayed through many nodes before returning to its initiating node.

11. A computer network interpretation system as in claim 10, wherein each of said many nodes applies a code to said at least one message object.

12. A computer network interpretation system as in claim 11, wherein said code indicates which of said nodes the present node received said at least one message object from, and a signature code for said receiving node to indicate receipt.

13. A computer network interpretation system as in claim 12, wherein said at least one message may be passed through an indefinite number of said nodes.

14. A computer network system as in claim 13, wherein when said at least one message is answered by one of said nodes, and is reversed to return to the initiator node.

15. A computer network system as in claim 14 wherein said code is read in a reverse format to return to said initiator node.

16. A computer network system as in claim 15, wherein said code is systematically removed by each node that applied said code.

17. A computer network system as in claim 16, wherein each node removes only the part of said code that it applied.

18. A computer network system as in claim 17, wherein said code may be encrypted if necessary in any format.

19. A computer network system as in claim 18, wherein said encryption is decrypted by the encrypting node when said message is returned to said initiator node.
